(19) United States
(12) Patent Application Publication
(10) Pub. No.: US 2006/0294033 A1
(43) Pub. Date: Dec. 28, 2006

(54) Educational system and method for encouraging children to choose a nutritional meal

(76) Inventor: Uzma Quraishi, Alexandria, VA (US)

Correspondence Address: LYTLE PATENT SERVICES, LLC, 18582 MERLON COURT, LEESBURG, VA, 20176, US

(21) Appl. No.: 11/150,173

(22) Filed: Jun. 13, 2005

(51) Int. Cl. G06F 17/00

(52) U.S. Cl. 705/500

(57) ABSTRACT

An educational system and method for encouraging children to choose a nutritional meal, designed to educate children in making healthy nutritional choices and rewarding them for so doing. The educational system and method for encouraging children to choose a nutritional meal has predefined menus featuring specific healthy food and beverage categories. An automatic identification device is used to identify food and beverage choices on the menu and then compare them to the food and beverage choice selected. The automatic identification device indicates a correct or incorrect choice accordingly. Upon successful completion of all food and beverage categories the child is provided an incentive. The educational system and method for encouraging children to choose a nutritional meal provides consistent feedback and incentives to enable children to develop healthy eating habits.

### BACKGROUND OF THE INVENTION

1. Field of the Invention

The present invention is related to computer systems and methods that aid children in their selection of child-oriented nutritional meals, and more specifically, child-oriented nutritional meals that are designed to educate the child in making healthy nutritional choices and rewarding them for doing so.

2. Discussion of the Background

Research continues to show that consuming healthy food and beverages increases the probability of favorable health conditions during life. In today's society, fast food and processed foods are becoming the norm in a majority of diets. Education in selecting healthy food and beverages is being directed to the attention of adults. However, it is also important to educate children in making healthy food and beverage choices, so that through their lives they will be aware of a healthier spectrum of food and beverage choices and make the best possible choices for a long and healthy life. In addition, there has been an increase in food allergies among children. Children need to be aware of the contents of the food they are eating, and more importantly, make food and beverage choices based on the ingredients of the consumable items.

Research continues to show that children are becoming obese and are suffering from the same health issues as adults. However, if children are taught to make healthy food and beverage choices early in life, healthy food and beverage choices will become a way of life for them through adulthood.

US Patent Application publication No. 2003/00665561 discloses a method, system, and program for providing consumer healthy habits incentives. A consumable item, consumed by an individual, is detected. A health factor is detected for the consumable item. An electronic incentive is selected for the individual according to the health factor, such that the individual is encouraged to consume a healthy selection of consumable items. An electronic incentive may be further specified according to the personal health history, exercise history and consumption history of an individual. The system includes a series of networked databases containing cross-referenced information from government agencies, health insurance providers, retail stores and restaurants, manufacturers and the like. This system is focused on the adult population, encouraging healthy food and beverage choices by tracking those food and beverage choices, assessing a health benefit, and distributing monetary incentives such as reduced costs of items and reduction in health insurance costs.

### SUMMARY OF THE INVENTION

One object of the present invention is to encourage healthy eating habits in children while enabling them to make their selections from a predefined menu. While this is just one object of the present invention, numerous other features and attributes of the present invention will become evident from the accompanying figures and detailed description of the preferred embodiments.

One feature of the present invention is to have several menus featuring healthy food and beverage choices available at a grocery store. Each menu features specific healthy food and beverage categories. The child is allowed to select his menu of choice and proceed to gather the food and beverage items designated by the categories listed on the menu in a designated container. In order to ensure the child has made an appropriate choice, an automatic identification device is used to identify the food and the beverage options on the menu and then compare them to the food and beverage choice selected. Upon successful selection, the automatic identification device indicates a correct choice. Upon an unsuccessful food or beverage choice, the automatic identification device indicates an incorrect choice and the child is required to select another item.

The purpose is to use this process to provide consistent feedback and incentives to enable children to develop healthy eating habits.

In a non-limiting example, the automatic identification device is a bar-code scanner. Alternatively, it is a radio frequency identification (RFID) monitor. The automatic identification device is located in a remote location in the grocery store. The child goes to the location of the remote automatic identification device to read in a menu, and then uses the automatic identification device to identify a first food or beverage choice. The automatic identification device indicates an acceptable or unacceptable choice. The child then selects the next food or beverage choice, goes to the remote automatic identification device location for the next food or beverage item to be identified. The automatic identification device indicates an acceptable or unacceptable choice. This process is repeated until the all the menu item categories are correctly selected.

In another embodiment, the child selects all of his food and beverage choices indicated on the menu and then goes to a remote automatic identification device. At that time the automatic identification device indicates if the food and beverage choices are acceptable or unacceptable. If the child has any unacceptable choices, he will be required to replace the unacceptable food or beverage choices with acceptable ones. He will need to go back to the automatic identification device and try again.

In another embodiment, identifiers are used throughout the store indicating the location of the Educational System and Method for Encouraging Children to Choose a Nutritional Meal (ESMECCNM) menu items. These identifiers along with the menus will aid the child in finding and selecting the appropriate menu items.

In another embodiment, the child is provided with a wireless automatic identification device and reads in his menu selection, and then uses the wireless automatic identification device to identify his food and beverage choices. The wireless automatic identification device indicates acceptable or unacceptable food and beverage choice. Food and beverage choices are made until all categories of the menu are successfully obtained.

These wireless automatic identification devices are owned by the food store and are optionally signed out and returned. If the wireless automatic identification device is not returned, it is deactivated and cannot be used again.

The child is given an incentive upon successfully filling the specified container with the appropriate food and beverage. The incentive can be, but is not limited to, a prize, a plaything, an electronic credit, at least one sticker, a token configured to be input to a token receiving box containing items appealing to children, or a document for the child to redeem for an incentive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a system block diagram of a network environment in which healthy food and beverage selections can be made in accordance with the present invention;

FIG. 2 is a database diagram of a network environment in which the food and beverage selected can be evaluated for correctness and incentives provided in accordance with the present invention;

FIGS. 3A and 3B are a logic flow chart of a process for encouraging healthy food and beverage selections in accordance with the present invention;

FIG. 4 is a sample menu in accordance with the present invention;

FIG. 5 is a sample picture menu in accordance with the present invention;

FIG. 6 is a sample advanced menu in accordance with the present invention;

FIGS. 7A and 7B illustrate a Menu Database in accordance with the present invention;

FIG. 8 illustrates a Choice Validation Database in accordance with the present invention;

FIG. 9 illustrates an Incentive Database in accordance with the present invention;

FIG. 10 illustrates an Automatic Identification Database in accordance with the present invention; and

FIG. 11 is a computer system block diagram.

### DETAILED DESCRIPTION OF THE INVENTION

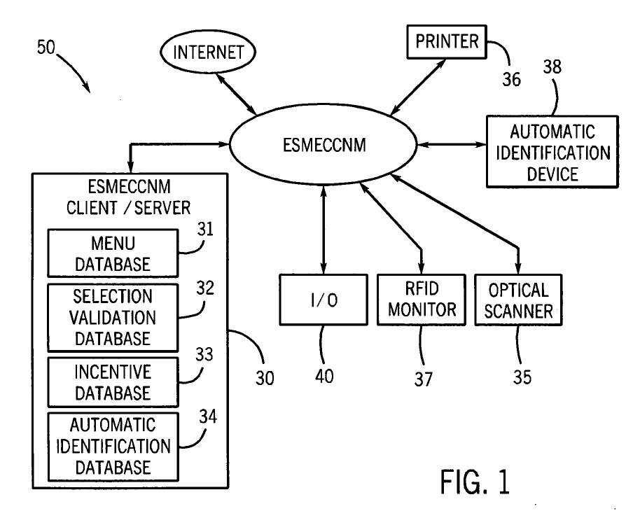

Referring now to the drawings, wherein like reference numerals designate identical or corresponding parts throughout the several views, and more particularly to FIG. 1, FIG. 1 shows one embodiment of a system block diagram of a computer network for an Educational System and Method for Encouraging Children to Choose a Nutritional Meal (ESMECCNM) 50 according to the present invention. The ESMECCNM network environment 50 provides a communication mechanism by which electronic information managed by the ESMECCNM is shared among the devices of the ESMECCNM network environment 50. The ESMECCNM network environment 50 is shown as a client/server architecture. The network 50 is shown to be communicatively connected to the Internet.

The client/server describes a relationship between two computer programs, wherein one computer program makes a service request from another computer program. The computer program making the request is referred to as the client. The computer program that implements the request is referred to as the server. The computer program making the request typically resides on a different computer than the computer program implementing the request. However, it is possible that the computer program making the request and the computer program implementing the request reside on the same computer. The network provides the means by which the client and server are able to communicate with each other.

The at least one client/server device 30 of the computer network for the ESMECCNM 50 is a database management system that maintains and manages information particular to the ESMECCNM according to the present invention. As a non-limiting example, FIG. 1 shows four databases that are managed by the ESMECCNM according to the present invention. The databases are organized by type of information. The database information includes, but is not limited to, a Menu Database 31, a Selection Validation Database 32, an Incentive Database 33, and an Automatic Identification Device Database 34. The input/output device 40 includes but is not limited to a printer 36, and an automatic identification device 38 including but not limited to an optical scanner 35 and a RFID monitor 37. The automatic identification device 38 is used to identify the food and beverages selected by the child and to provide feedback indicating if the food or beverage choice is acceptable or unacceptable. An acceptable food and beverage choice is indicated by at least one of a sound indicator and a display indicator. The acceptable sound indicator is a conventional sound for “acceptable”. The acceptable display indicator is at least one of a luminous bulb, LED, or the like in a color, such as green, that is conventional for “acceptable”, an illuminated conventional symbol for “acceptable”, or an illuminated conventional character for “acceptable”. An unacceptable food or beverage choice is indicated by at least one of a sound indicator and a display indicator. The unacceptable sound indicator is differentiated from the acceptable sound indicator and the unacceptable display indicator is differentiated from the acceptable display indicator. The unacceptable sound indicator is a conventional sound for “unacceptable”. The unacceptable display indicator is at least one of a luminous bulb, LED, or the like in a color, such as red, that is conventional for “unacceptable”, an illuminated conventional symbol for “unacceptable”, or an illuminated conventional character for “unacceptable”.

It is not necessary for the network environment 50 to be an exclusively wired network. Wireless technology, such as radio frequency transmissions, can be substituted as the environment develops and expands, as will be understood by one skilled in the art.

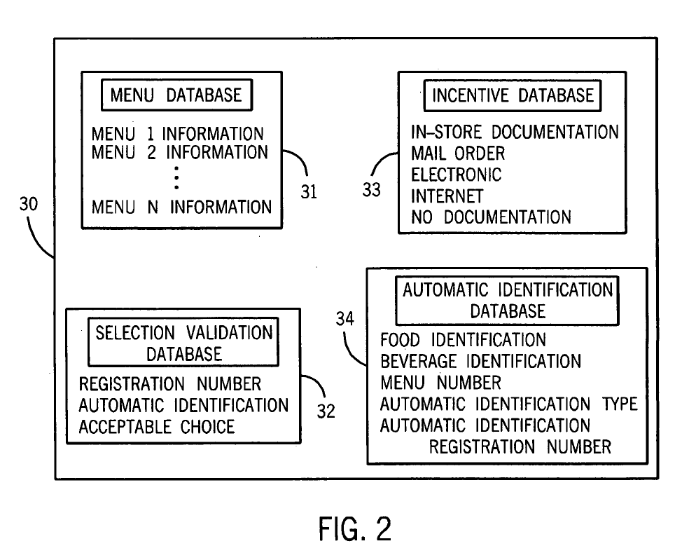

FIG. 2 is a database diagram of an Educational System for Encouraging Children to Choose a Nutritional Meal according to the present invention. As shown, at least one client/server device manages the ESMECCNM database information whereby the food and beverage selected can be evaluated for correctness and incentives.

The ESMECCNM maintains at least one database server 30 which hosts: a Menu Database 31, a Selection Validation Database 32, an Incentive Database 33, and an Automatic Identification Database 34. The Menu Database 31 maintains a variety of healthy food and beverage choice menus to be used by the child while gathering his food and beverage choices. The variety of healthy food and beverage choice menus will also provide menus specific to children with food and beverage allergies, thereby maintaining and supplying menus that include but are not limited to peanut free, soy free, dairy free, fish free, and gluten free. The Menu Database 31 also maintains a registration of the menus in use.

The Selection Validation Database 32 maintains an inventory of healthy food and beverage choices and is used to compare the food and beverage selected with the choices provided by the selected menu. Both correct choices and incorrect choices are stored for future reporting capabilities.

The Incentive Database 33 maintains information regarding the type of incentive to be provided. Incentives are either redeemed at the store, via the internet, or via the U.S. postal system.

The Automatic Identification Database 34 maintains information regarding food choices, beverage choices, menu information, and automatic identification data.

These databases are configured to communicate information among each other. For example, in order to provide feedback to the child, a field in the Selection Validation Database 32 is filled with an appropriate indicator upon an acceptable selection, and a corresponding category in the Menu Database 31 is filled accordingly, indicating that the corresponding category is complete. The child is then provided an indication that the category has been completed correctly. If however, the child makes an unacceptable choice, a field in the Selection Validation Database 32 is filled with a corresponding (negative) indicator and the Menu Database 31 is filled with a corresponding (negative) indicator and the category is not complete. Therefore, the child is given the appropriate feedback and must continue to select items for the category until an acceptable item is selected. Once all the categories have been successfully completed, the Incentive Database 33 generates the appropriate documentation.

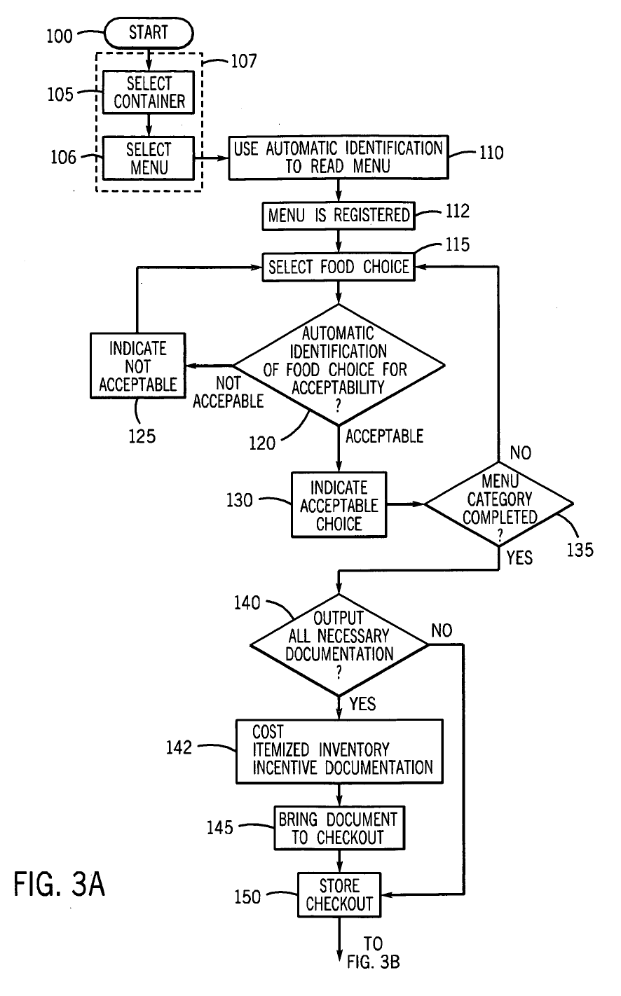

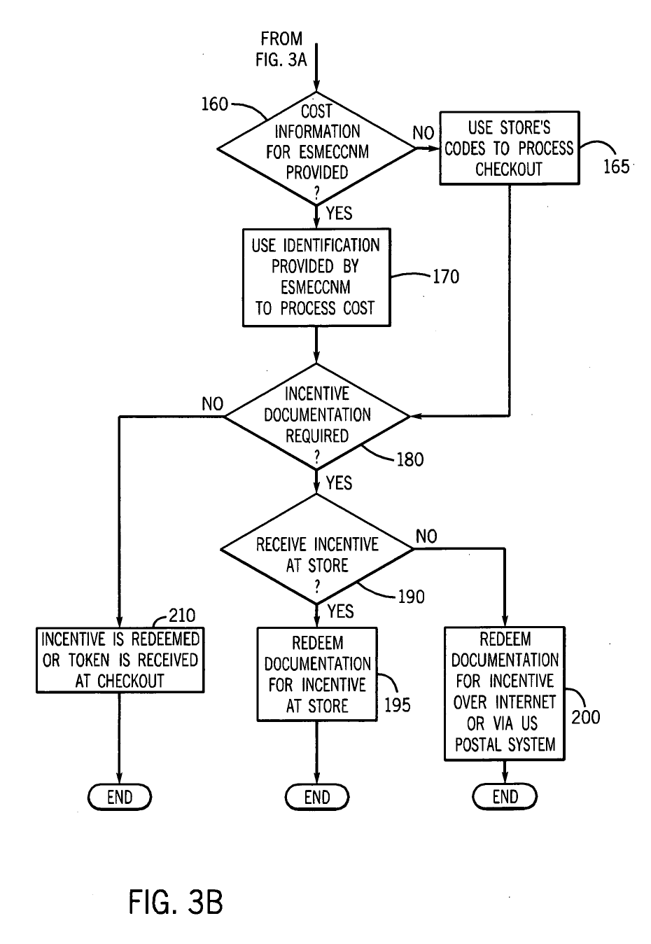

FIGS. 3A and 3B describe a logic flow chart of a process for encouraging healthy food and beverage selections in accordance with the method and system of the present invention. The process starts at step 100 and thereafter proceeds to Step 105, where the child obtains a container that holds the selected menu items. Subsequently, the process proceeds to Step 106 where the child selects a menu to use in choosing a nutritional meal.

In another embodiment, Step 107 is a combination of Step 105 and Step 106 where the menu is an integral part of the container. Therefore, when the child selects a menu, the container is obtained at the same time.

The menu is written words, or conventional illustrations of the food and beverage choices, or a combination of written words and conventional illustrations. The menu includes a code (bar-code, or memory, such as an RFID) that includes a list of items contained in the menu. This code is machine readable, such that the menu items may easily be correlated with identifiers of the food items in use by the food store. The menu is either separate from the container that holds the selected menu items, or is adhered to the container that holds the selected menu items, or is printed on the container that holds the selected menu items. Some menus will be specific to customers with food allergy concerns. These menus will identify food and beverage choices that include, but are not limited to, peanut free choices, soy free choices, gluten free choices, dairy free choices, and fish free choices.

Subsequently, the process proceeds to Step 110 where the customer uses an automatic identification device to input the menu information into the Automatic Identification Database 34. The process then proceeds to Step 112 where the selected menu is registered in the Menu Database 31, and then in Step 115 the customer makes food or beverage choice based upon the selected menu. Subsequently, the process proceeds to Step 120 where the customer uses an automatic identification device to determine if the selected food and beverage item meets the criteria of the selected menu. The automatic identification device 38 interprets food and beverage choices (e.g., by recognizing the UPC code on the food item). A comparison is made between the selected food and beverage choice and the information maintained for the selected menu maintained in the Menu Database 31. If the food and beverage choice is acceptable, the Menu Database 31 tags the “category complete” field as complete. Subsequently, the process proceeds to Step 130 whereby the automatic identification device 38 provides positive feed back to the customer by emitting a response indicating that the choice was acceptable. Subsequently, the process proceeds to Step 135 where a determination is made if all menu categories have been correctly selected. The determination is made by a process checking the Menu Database 31 for completion of all categories for the selected menu.

During Step 120, if the automatic identification device 38 determines that the food or beverage choice is not acceptable, the Menu Database 31 field “category complete” is not tagged and the process proceeds to Step 125 whereby the automatic identification device 38 provides feedback to the customer by emitting a response indicating that the choice was not acceptable. The customer then returns to Step 115 to make another selection.

Once all menu categories are determined to be complete in Step 135, the process proceeds to Step 140 where a determination is made if the ESMECCNM provides output documentation to the customer. If the ESMECCNM provides output documentation to the customer, the process proceeds to Step 142. In a non-limiting example, FIG. 3 shows the output documentation provided in Step 142 to be at least one of an itemized inventory of the selected food and beverage items, cost information, and incentive redemption information. In one embodiment the itemized inventory is a self adhesive label that is adhered to the completed container that holds the selected menu items. The output documentation may be in bar code format, RFID format, electronic format, or paper format. The process proceeds to Step 145, whereby the customer brings the completed container that holds the selected menu items and the associated documentation to the store's checkout procedure, Step 150.

The incentive documentation produced during Step 142 provides the customer with information pertaining to redemption of the incentive. The incentive will be obtained at the time of check out at a specific location in the store, via the internet, or via the U.S. postal system. To redeem the incentive at the specific location in the store the customer provides the incentive documentation to, (1) a store employee in exchange for the incentive, (2) a store employee in exchange for an incentive token, whereby the incentive token is placed into a designated incentive machine, or (3) a designated incentive machine (which could be a web site) in exchange for the incentive.

If it is determined in Step 140 that the ESMECCNM system did not output all necessary printed documentation, the process proceeds to Step 150 and the child brings the correctly completed container that holds the selected menu items and any output documentation provided by the ESMECCNM to the store's check out procedure. The store uses their internal systems and processes to complete the transaction. Subsequently, the process proceeds to Step 160 where a determination is made if the ESMECCNM system provided cost output. If the ESMECCNM provided the cost of the contents of the correctly completed container, the process proceeds to Step 170 whereby the cost output of the ESMECCNM system is used in the store's checkout process. Subsequently, the process proceeds to Step 180. However, if during Step 160, if it is determined that the ESMECCNM system did not provide cost output, then the process proceeds to Step 165 and the grocery store's process for determining the cost of the items is used. The items are removed from the container and the individual items are processed through the grocery store's system or the store has a set cost for the completed container. Subsequently, the process proceeds to Step 180.

During Step 180, a determination is made if the incentive documentation is required to obtain the incentive. If the incentive documentation is not required to obtain the incentive, then the process proceeds to Step 210 whereby the incentive is obtained at the time of checkout, or an incentive token is provided to the child at the time of checkout, whereby the incentive token is placed into a designated incentive and the ESMECCNM process is complete. However, if during Step 180 it is determined that the incentive documentation is required to obtain the incentive, then the process proceeds to Step 190.

During Step 190, a determination is made if the incentive documentation is used to redeem the incentive in the grocery store. If the incentive documentation is used to redeem the incentive in the grocery store, then the process proceeds to Step 195 and the child goes to the appropriate location in the grocery store to receive his incentive. The incentive documentation is read by an automatic identification reader and the incentive is provided to the customer, or the incentive documentation is given to a store employee for exchange of the incentive, or the incentive documentation is given to a store employee in exchange for an incentive token, whereby the incentive token is placed into a designated incentive machine and the ESMECCNM process is complete. If the incentive documentation is not used to redeem the incentive in the store, then the process proceeds to Step 200 and the incentive documentation is used to redeem an incentive over the internet or via the U.S. postal system and the ESMECCNM process is complete.

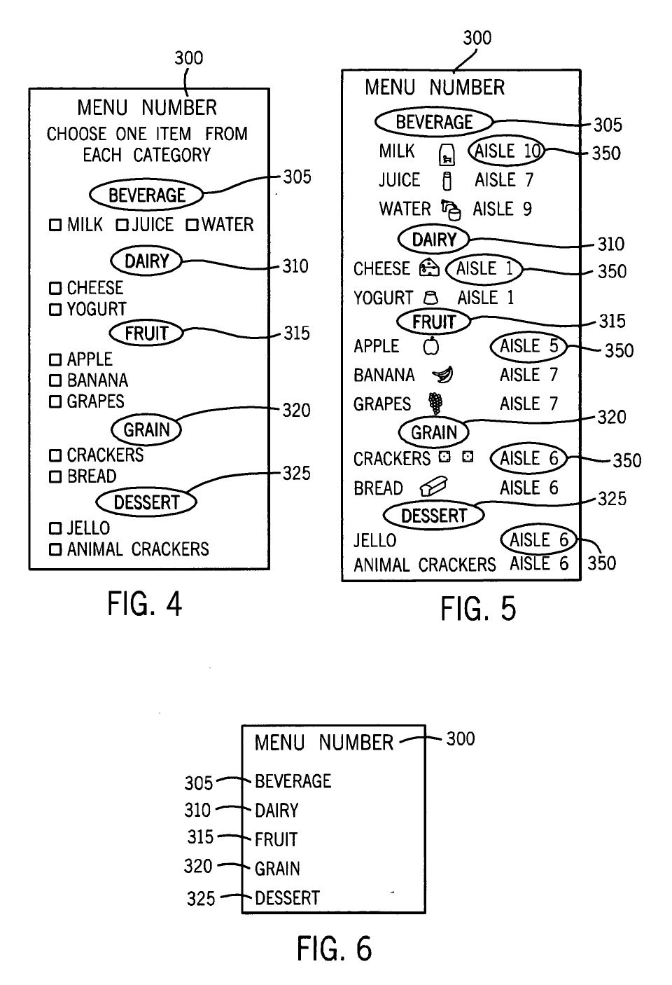

FIG. 4 is a sample menu in accordance with the method and system of the present invention. The menu number 300 is a unique identifier for specific menu choices. The BEVERAGE category 305 identifies anywhere between one and ten healthy acceptable beverage choices. A non-limiting example in FIG. 4 is illustrated where three beverage choices including milk, juice and water are shown. The menu shown in FIG. 4, identifies anywhere between three and ten food categories. A non-limiting example in FIG. 4 is illustrated where four food categories including DAIRY 310, FRUIT 315, GRAIN 320, and DESSERT 325 are shown. The DAIRY 310 category shown in FIG. 4, identifies anywhere between one and ten dairy choices. A non-limiting example in FIG. 4 is illustrated where two dairy choices including cheese and yogurt are shown. The FRUIT 315 category shown in FIG. 4 identifies anywhere between one and ten fruit choices. A non-limiting example in FIG. 4 is illustrated where three fruit choices including an apple, a banana, and grapes are shown. The GRAIN 320 category shown in FIG. 4, identifies anywhere between one and ten grain choices. A non-limiting example in FIG. 4 is illustrated where two grain choices including crackers and bread are shown. The DESSERT 325 category shown in FIG. 4, identifies anywhere between one and ten dessert choices. A non-limiting example in FIG. 4 is illustrated where two dessert choices including JELLO and animal crackers are shown. The menu may be printed or displayed on a portable device (e.g. PDA).

FIG. 5 is another embodiment of the present invention where a sample picture menu is shown in accordance with the method and system of the present invention. The menu number 300 is a unique identifier for specific menu choices. In addition to the written menu of FIG. 4, FIG. 5 includes pictures of the choices. In another embodiment, the picture menu also includes the location of the food and beverage items in the store. The BEVERAGE category 305 identifies anywhere between one and ten healthy acceptable beverage choices. A non-limiting example in FIG. 5 is illustrated where three beverage choices including milk, juice and water are shown in written format and pictorial format. In a non-limiting example, an aisle location 350 is also provided. The menu shown in FIG. 5, identifies anywhere between three and ten food categories. A non-limiting example in FIG. 5 is illustrated where four food categories including DAIRY 310, FRUIT 315, GRAIN 320, and DESSERT 325 are shown. The DAIRY 310 category shown in FIG. 5, identifies anywhere between one and ten dairy choices. A non-limiting example in FIG. 5 is illustrated where two dairy choices including cheese and yogurt are shown in written format and pictorial format. In a non-limiting example, an aisle location 350 is also provided. The FRUIT 315 category shown in FIG. 5, identifies anywhere between one and ten fruit choices. A non-limiting example in FIG. 5 is illustrated where three fruit choices including an apple, a banana, and grapes are shown in written format and pictorial format. In a non-limiting example, an aisle location 350 is also provided. The GRAIN 320 category shown in FIG. 5, identifies anywhere between one and ten grain choices. A non-limiting example in FIG. 5 is illustrated where two grain choices including crackers and bread are shown in written format and pictorial format. In a non-limiting example, an aisle location 350 is also provided. The DESSERT 325 category shown in FIG. 5, identifies anywhere between one and ten dessert choices. In a non-limiting example in FIG. 5 is illustrated where two dessert choices including JELLO and animal crackers are shown in written format and pictorial format. In a non-limiting example, an aisle location 350 is also provided.

FIG. 6 is another embodiment of the present invention where a sample advanced menu is shown in accordance with the method and system of the present invention. The menu number 300 is a unique identifier for specific menu choices. The menu shown in FIG. 6 identifies between one and ten beverage and food categories. A non-limiting example in FIG. 6 is illustrated where five categories including BEVERAGE 305, DAIRY 310, FRUIT 315, GRAIN 320, and DESSERT 325 are shown. This menu is used by more advanced customers that do not require specific choices in each category.

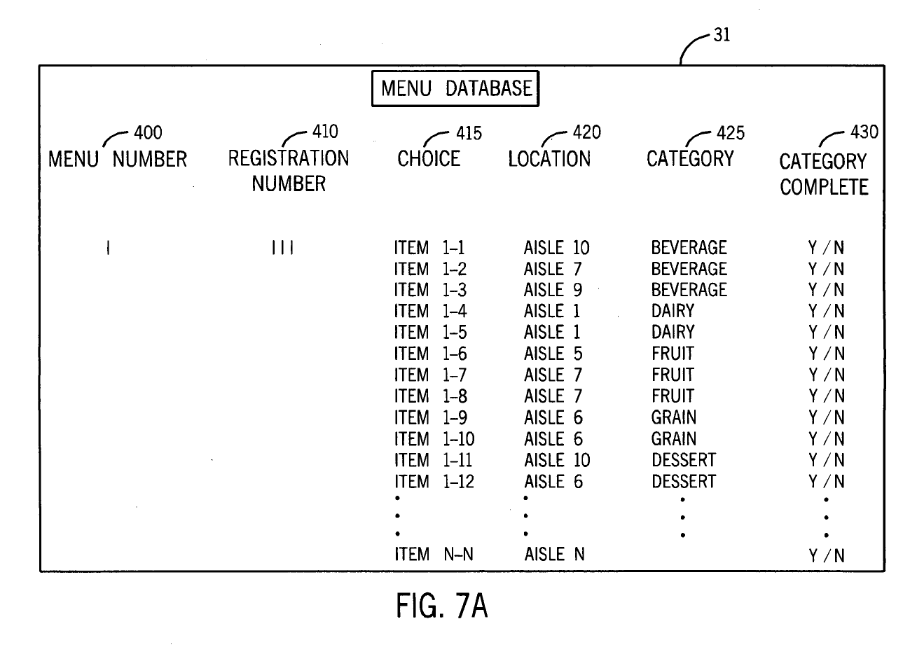

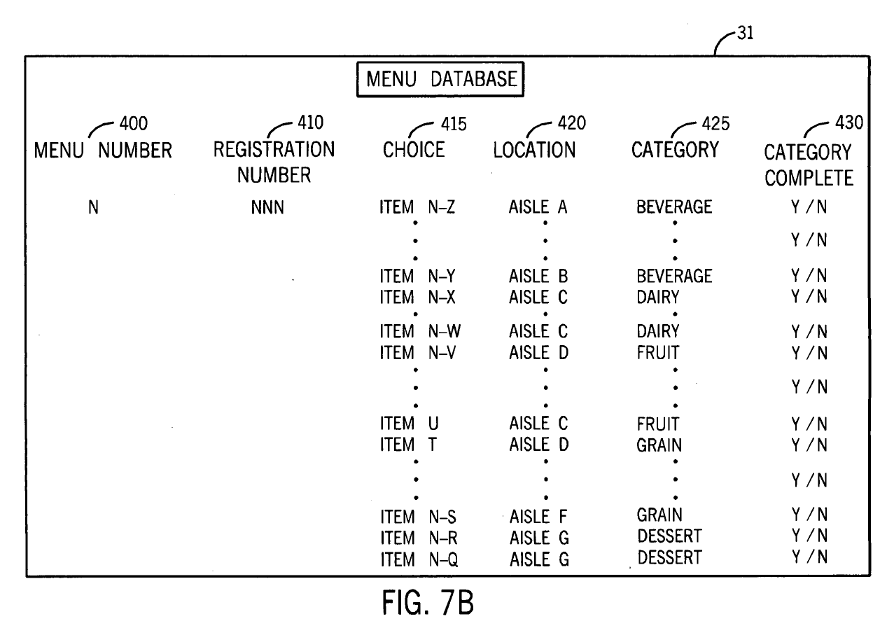

FIGS. 7A and 7B illustrate a Menu Database 31 in accordance with the method and system of the present invention. As illustrated, the Menu Database 31 includes a variety of healthy menu choices available that are each broken down into a menu number field 400, a registration number field 410, a choice field 415, a location field 420, a category field 425, and a category complete field 430. The menu number field 400 is used to maintain a unique identifier for each menu. The registration number field 410 is used to register the selected menu in use by the child. A choice field 415 maintains acceptable beverage choices and acceptable food choices associated with each menu and are used in the determination of acceptable choices. The acceptable food choices and acceptable beverage choices are associated to the Category Field 425. These associations are used to identify completion of a menu category. The location field 420 maintains the location of the acceptable beverage choices and food choices within the store, for example, the aisle number for the location of the selection is maintained. The category complete field 430 is an identifier to indicate when a category has been successfully completed for a specific menu. As a non-limiting example, FIG. 7 shows a Menu Database 31 with two menu numbers and associated fields.

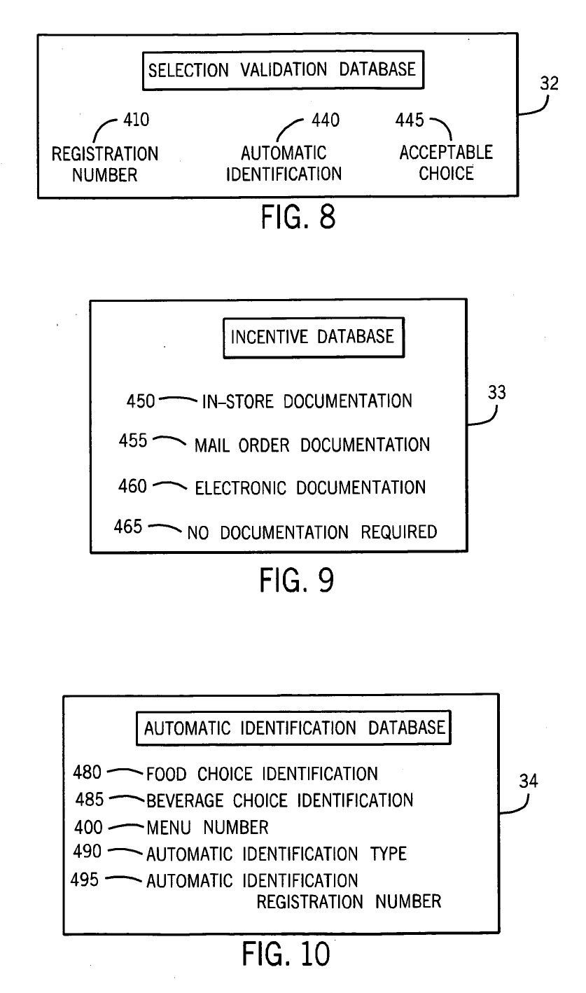

FIG. 8 illustrates a Selection Validation Database 32 in accordance with the present invention. As illustrated, the Selection Validation Database 32 includes a registration number field 410, an automatic identification field 440, and an acceptable choice field 445. The registration number field 410 is used to maintain a unique identifier for each menu. The automatic identification field 440 stores the identifier for all food and beverage choices selected by the child. An acceptable choice field 445 is filled with an appropriate indicator upon an acceptable selection or is filled with another indicator upon an unacceptable selection. This information is used to generate reports to indicate where the child was able to make acceptable choices and where the child was unable to make acceptable choices.

FIG. 9 illustrates an Incentive Database 33 in accordance with the present invention. The incentive is redeemed by using one of these documents; in-store documentation 450, mail order documentation 455, electronic documentation 460, and no documentation required 465.

FIG. 10 illustrates an Automatic Identification Database 34 in accordance with the present invention. The Automatic Identification Database 34 captures, reads, and maintains food choice data, beverage choice data, menu data and automatic identification data. A food choice field 480 maintains all food choices selected by the child. A beverage choice field 485 maintains all beverage choices selected by the child. A menu number field 400 is used to maintain a unique identifier for each menu. An automatic identification type field 490 maintains the type of automatic identification device in use. The automatic identification registration number field 495 maintains the unique identifier of the automatic identification device in use. The automatic identification method used includes but is not limited to RFID, optical scanner, and barcode technologies.

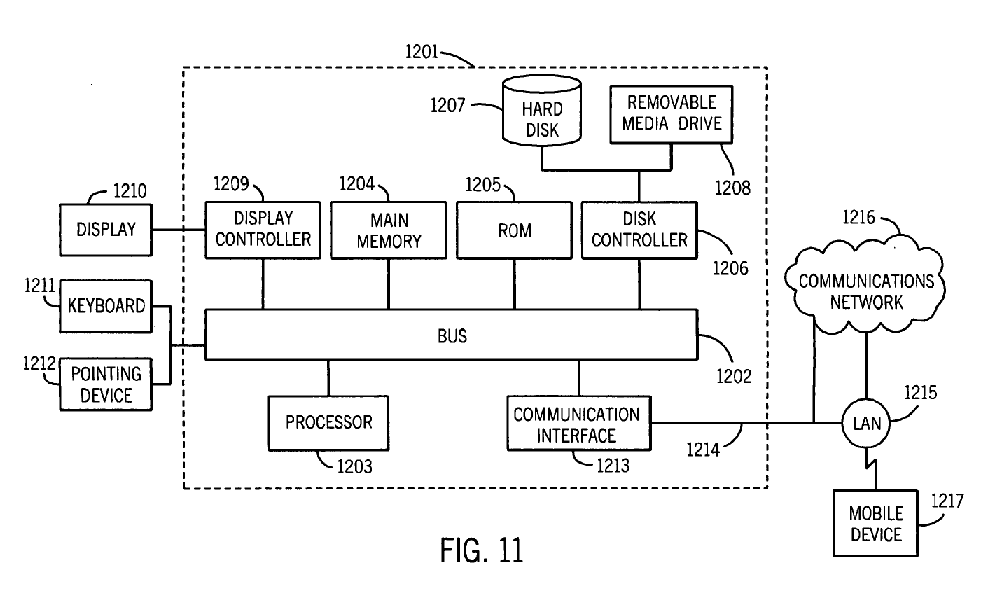

FIG. 11 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

I claim:

1. A computer-implemented educational method for encouraging a user to choose a nutritional meal, comprising the steps of:
a) identifying a menu of entries;
b) detecting a consumable item selected by said user and storing a detection result in memory;
c) comparing with a processor the detection result with the entries on the menu to determine if there is a match;
d) repeating steps (b) and (c) until at least a predetermined portion of said menu of entries have been compared with consumable items selected by the user; and
e) outputting at least one of a tangible item and an electronic indicia redeemable for a tangible product as an incentive to said user for making healthy choices.

2. The method according to claim 1, wherein said step of identifying a menu further comprises receiving an identifier of said menu from an automatic identification device.

3. The method according to claim 1, wherein said menu is an integral part of a container.

4. The method according to claim 1, wherein said detecting step further comprises receiving an identifier of said consumable item from an automatic identification device.

5. The method according to claim 4, wherein said receiving step includes scanning with at least one of an RFID monitor and an optical scanner.

6. The method according to claim 1, wherein said comparing step further comprises the steps of:
a) storing in the memory the entries on the menu;
b) identifying a predetermined consumable item that corresponds with at least one of the entries on the menu; and
c) providing at least one of an audio and a video feedback to said user as an indication of a match or not a match.

7. The method according to claim 1, wherein said repeating step further comprises the steps of:
a) storing in the memory the categories on the menu;
b) identifying a completed category that corresponds with at least one of a plurality of categories on the menu; and
c) providing at least one of an audio and a video feedback to said user as an indication of a match or not a match.

8. The method according to claim 1, wherein said tangible incentive includes at least one of a prize, a plaything, a sticker, a token configured to be input to a token receiving box, and a document.

9. The method for according to claim 1, wherein said electronic indicia includes an electronic credit.

10. The method according to claim 9, wherein said electronic credit is redeemable at a point of sale.

11. The method according to claim 9, wherein said electronic credit is associated with a document that is redeemable at a point of sale in a reward dispenser configured to read said document.

12. The method according to claim 9, wherein said electronic credit is redeemable at a remote location via the Internet.

13. An educational apparatus for encouraging a user to choose a nutritional meal, comprising:
a processor;
a memory configured to be accessed by said processor, said memory including
a menu database,
a selection validation database,
an automatic identification database, and
an incentive database;
at least one input/output device wherein said processor is configured to receive an indication of a menu in use,
detect a first consumable item selected by said user and store a detection result in memory,
compare an the detection result with the entries on the menu to determine if there is a match,
detect another consumable item selected by said user and compare the detection result with the entries on the menu to determine if there is a match,
output at least one of a tangible item and an electronic indicia redeemable for a tangible product as an incentive to said user for making healthy choices, and
provide at least one of an audio and a video feedback to said user as an indication of a match or not a match.

14. The educational apparatus according to claim 13, wherein said at least one input/output device comprising at least one of a printer and an automatic identification device.

15. The educational apparatus according to claim 14, wherein said automatic identification device being one of an RFID monitor and an optical scanner.

16. The educational apparatus according to claim 15, wherein an identifier of said menu is received from said automatic identification device.

17. The educational apparatus according to claim 15, wherein an identifier of at least one of said first consumable item and said another consumable item is received from said automatic identification device.

18. The educational apparatus for encouraging children to choose a nutritional meal of claim 14, wherein said processor is configured to
receive and indication of at least one category on the menu,
detect a first completed category that corresponds with the at least one category on the menu and store a detection result in memory,
determine if another category on said menu is to be completed, and
provide at least one of an audio and a video feedback to said user as an indication of a match or not a match.
